(19) United States
(12) Patent Application Publication
(10) Pub. No.: US 2025/0067904 A1
(43) Pub. Date: Feb. 27, 2025

(54) ANTI-REFLECTIVE MULTI-LAYER SYSTEMS

(71) Applicant: Tesla, Inc., Austin, TX (US)

(72) Inventor: Chih Hsieh Chen, San Jose, CA (US)

(21) Appl. No.: 18/724,101

(22) PCT Filed: Jan. 12, 2023
(86) PCT No.: PCT/US2023/010704

§ 371 Date: Jun. 25, 2024

Related U.S. Application Data
(60) Provisional application No. 63/299,810, filed on Jan. 14, 2022.

(51) Int. Cl. G02B 1/111; G02B 5/30

(52) U.S. Cl. CPC G02B 1/111; G02B 5/3016; G02B 5/3083

(57) ABSTRACT

Provided herein are anti-reflective multi-layer systems and methods of using the same. In particular, the various embodiments described herein include display systems and methods and using the same.

### INCORPORATION BY REFERENCE TO ANY PRIORITY APPLICATIONS

This application is a non-provisional of and claims priority to U.S. Provisional Patent Application No. 63/299,810, entitled “METHODS FOR REDUCED GLARE SURFACES REFLECTION AND SYSTEMS THEREOF,” filed on Jan. 14, 2022, which is hereby incorporated by reference in its entirety and for all purposes.

### TECHNICAL FIELD

The present disclosure relates generally to methods of making and using reduced glare surfaces reflection and systems thereof.

### BACKGROUND

Light from an external light source that is incident on a given surface can be reflected off the surface, thereby, obstructing the underlying surface and its contents. Similarly, when the incident light is attributed to an internal light source, such as a backlight unit, the internally reflected light may reduce the total amount of light passing through the surface and diminish the visibility of the lower surface image. As such, anti-glare and anti-reflection techniques and systems are necessary to minimize external and internal reflections of light.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, an anti-reflective multi-layer system is disclosed. The system includes: a cover system positioned at a proximal end of the anti-reflective multi-layer system, and including a first polarization layer positioned proximally to a first light-retardation layer; a reflective system positioned at a distal end of the anti-reflective multi-layer system, and comprising at least one reflective surface; and an air gap disposed between the cover system and the reflective system.

In some embodiments, a retardation value of the first light-retardation layer is between about 100 nm to about 140 nm. In some embodiments, the first light-retardation layer comprises a quarter wave plate. In some embodiments, a dispensation of the first light-retardation layer is flat or negative. In some embodiments, the first light-retardation layer comprises a liquid crystal polymer layer.

In some embodiments, the cover system further comprises a transparent layer. In some embodiments, the transparent layer is positioned proximally to the first polarization layer. In further embodiments, the transparent layer is selected from the group consisting of a curved glass, a flat glass, a plastic film, and combinations thereof. In some embodiments, the transparent layer further comprises a coating layer selected from the group consisting of an anti-reflection coating, an anti-glare coating, a hard coating, a scratch-resistance coating, an impact-resistant coating, an abrasion-resistant coating, and combinations thereof. In some embodiments, the cover system further comprises an adhesive layer disposed between the transparent layer and the first polarization layer.

In some embodiments, the at least one reflective surface is a surface of a layer selected from the group consisting of an anti-reflection coating, an anti-glare coating, a hard coating, a scratch-resistance coating, an impact-resistant coating, an abrasion-resistant coating, a curved glass, a flat glass, a plastic film, an adhesive layer, a second polarization layer, and combinations thereof. In some embodiments, the anti-reflective multi-layer system is configured to reduce the intensity of an external light beam reflected from the at least one reflective surface by at least about 50%.

In some embodiments of the present disclosure, the reflective system further comprises a second polarization layer positioned distally to the at least one reflective surface. In some embodiments, a transmittance axis of the first polarization layer is approximately equal to a transmittance axis of the second polarization layer. In some embodiments, the reflective system further comprises a second light-retardation layer positioned between the at least one reflective surface and the second polarization layer. In some embodiments, the reflective system further comprises a light generating layer positioned distally to the second polarization layer. In further embodiments, the anti-reflective multi-layer system is configured to reduce the intensity of an internal light beam produced by the light generating layer and transmitted through the proximal end of the anti-reflective multi-layer system by at most about 25%.

In some embodiments, the reflective system further comprises a display system positioned distally to the at least one reflective surface. In some embodiments, the display system is selected from the group consisting of a liquid-crystal display (LCD), an image display panel, a plasma display panel (PDP), a light emitting diode (LED), an organic light emitting diode (OLED), a cathode ray tube (CRT), a cold cathode fluorescent lamp (CCFL), an external electrode fluorescent lamp (EEFL), a backlight unit, a projector, and combinations thereof.

In another aspect, a vehicle including a display system is disclosed.

In another aspect, a method of reducing reflected light is disclosed. The method includes exposing an anti-reflective multi-layer system to an external light beam, wherein: the external light beam passes through the cover system to form a circularly polarized beam; the circularly polarized beam passes through the air gap and is reflected by the reflected surface to form a reflected circularly polarized beam; the reflected circularly polarized beam passes through the air gap and the cover system to form an exit beam; and an intensity of the exit beam is less than an intensity of the external light beam.

In another aspect, a method of increasing transmitted light is disclosed. The method includes generating an internal light beam from the light generating layer of the anti-reflective multi-layer system of the present disclosure, wherein: the internal light beam passes through the second polarization layer and the second light-retardation layer to form a circularly polarized beam; the circularly polarized beam passes through the air gap and the cover system to form an emitted beam; and an intensity of the emitted beam is at least about 75% of an intensity of the internal light beam.

### BRIEF DESCRIPTION OF THE DRAWINGS

FIG. 1 is a schematic depiction of an anti-reflective multi-layer system configured to reduce the intensity of an external light beam, according to one embodiment.

FIG. 2 is a schematic depiction of an external light beam passing through a cover lens and air gap, before being reflected by a reflective surface to form a reflected circularly polarized beam.

FIG. 3 is a cross-sectional view of an anti-reflective multi-layer system configured to reduce the intensity of an external light beam, according to one embodiment, that includes one light-retardation layer.

FIG. 4 is a schematic depiction of an anti-reflective multi-layer system configured to maintain the intensity of an internal light beam, according to one embodiment.

FIG. 5 is a cross-sectional view of an anti-reflective multi-layer system configured to maintain the intensity of an internal light beam, according to one embodiment, that includes two light-retardation layers.

### DETAILED DESCRIPTION

The present disclosure relates to an anti-reflective multi-layer system that include multiple systems (e.g., cover system and reflective system) that are stacked with an air gap between. In such a configuration, each glass structure has its own reflectance. The double reflectance creates a ghost image which can be distracting when viewing vehicle information displayed by the display system. In certain embodiments, the display systems disclosed herein include one or more light-retardation layer (e.g., quarter-wave plates) configured to convert linearly polarized light beams into circularly polarized beams. In certain embodiments, the display systems disclosed herein include one or more polarization layers.

As used herein, some embodiments of the present disclosure relate to an anti-reflective multi-layer system, including: a cover system positioned at a proximal end of the anti-reflective multi-layer system; a reflective system positioned at a distal end of the anti-reflective multi-layer system; and an air gap disposed between the cover system and the reflective system.

### Anti-Reflective Multi-Layer System and Methods Thereof

Some embodiments of the present disclosure relate to an anti-reflective multi-layer system and methods of reducing reflected light. An anti-reflective multi-layer system comprises a cover system, a reflective system and an air gap. In some embodiments, the cover system is positioned at a proximal end of the anti-reflective multi-layer system. In some embodiments, the reflective system is positioned at a distal end of the anti-reflective multi-layer system. In some embodiments, the air gap is disposed between the cover system and the reflective system. In some embodiments, the cover system comprises a first polarization layer positioned proximally to a first light-retardation layer. In some embodiments, the reflective system comprises at least one reflective surface.

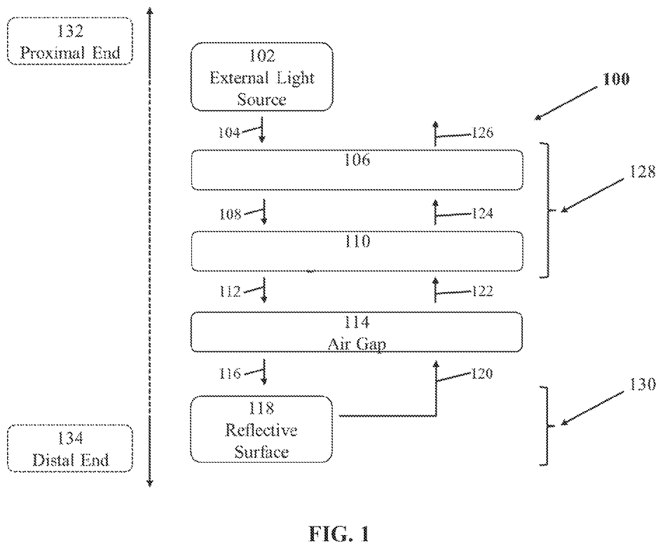

FIG. 1 is a schematic depiction of a cross-sectional view of an anti-reflective multi-layer system 100 and methods thereof. The anti-reflective multi-layer system 100 comprises a cover system 128, a reflective system 130, and an air gap 114. The cover system 128 is positioned at the proximal end 132 of the anti-reflective multi-layer system 100, the reflective system 130 is positioned at the distal end 134 of the anti-reflective multi-layer system 100, and the air gap 114 is disposed between the cover system 128 and the reflective system 130. As used herein, the “proximal end” refers to the end closer to the observer or outer surface of the system. In some embodiments, the proximal end of an anti-reflective multi-layer system is highly visible to an observer or is the most obvious to the direct line of vision. As used herein, the “distal end” refers to the end further from the observer or inner surface of the system. In some embodiments, the distal end of an anti-reflective multi-layer system may not be visible to an observer or is not in the direct line of vision. The cover system 128 comprises a first polarization layer 106 and a first light-retardation layer 110. The first polarization layer 106 is positioned proximally to the first light-retardation layer 110. The reflective system 130 comprises at least one reflective surface 118.

As depicted in FIG. 1, an external light source 102 emits a light beam 104 into the anti-reflective multi-layer system 100. In some embodiments, the light beam 104 is unpolarized. In some embodiments, the light beam 104 is polarized or partially polarized. In some embodiments, the light beam 104 is linearly polarized. The light beam 104 passes through the first polarization layer 106, causing the light beam 104 to become a polarized light beam 108. The polarized light beam 108 passes through the first light-retardation layer 110 to become a circular polarized light beam 112. The circular polarized light beam 112 passes through the air gap 114 and remains a circular polarized light beam 116. The circular polarized light beam 116 reflects from at least one reflective surface 118 to become a reflected circular polarized light beam 120. The reflected circular polarized light beam 120 passes through the air gap 114 and remains a reflected circular polarized light beam 122. The reflected circular polarized light beam 122 passes through the first light-retardation layer 110 to become a reflected linear polarized light beam 124, with a polarization axis perpendicular to that of the first polarization layer 106. Accordingly, the intensity of the linear polarized light beam 124 is partially, is substantially, or is reduced by the first polarization layer 106 to form an exit beam 126.

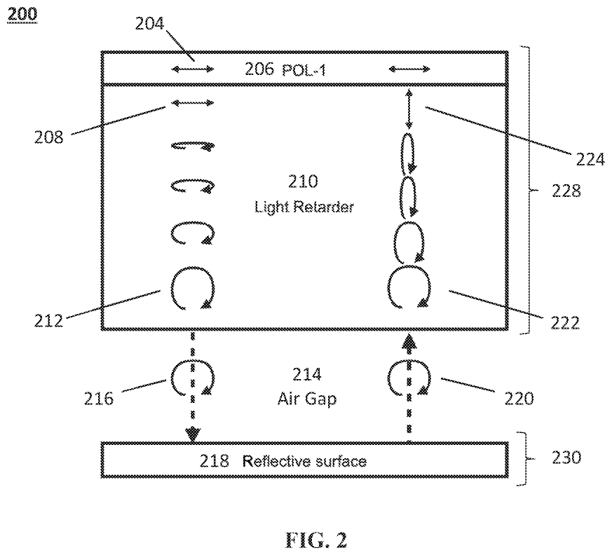

FIG. 2 depicts the pathway and polarization traveled by the external light beam through an anti-reflective multi-layer system 200 and methods thereof. FIG. 2 is a schematic depiction of the anti-reflective multi-layer system 200 comprising a cover system 228; a reflective system 230; and an air gap 214. The cover system 228 is positioned at the proximal end of the anti-reflective multi-layer system 200, the reflective system 230 is positioned at the distal end of the anti-reflective multi-layer system 200, and the air gap 214 is disposed between the cover system 228 and the reflective system 230. The cover system 228 comprises a first polarization layer 206 (POL-1) and a first light-retardation layer 210. The first polarization layer 206 is positioned proximally to the first light-retardation layer 210. The reflective system 230 comprises at least one reflective surface 218.

As illustrated in FIG. 2, an external light source passes through the first polarization layer 206 to form a linear horizontal polarized light beam 204. The linear horizontal polarized light beam 204 when initially passing into the first light-retardation layer 210 is depicted as a linear horizontal polarized light beam 208. The linear horizontal polarized light beam 208 passes through the first light-retardation layer 210 to become a circular polarized light beam 212, and passes into the air gap 214 as a circular polarized light beam 216. The circular polarized light beam 216 reflects from at least one reflective surface 218 to become a reflected circular polarized light beam 220, wherein the distance depicted between the circular polarized light beam 216 and the reflected circular polarized light beam 220 is for the purpose of illustrative clarity. The reflected circular polarized light beam 220 passes through the air gap 214 into the first light-retardation layer 210 to initial become a reflected circular polarized light beam 222. The reflected circular polarized light beam 222 passes through the first light-retardation layer 210 to become a linear vertical polarized light beam 224, with a polarization axis perpendicular to that of the first polarization layer 206. Accordingly, the linear vertical polarized light beam 224 is blocked from exiting the first polarization layer 206.

In some embodiments, the anti-reflective multi-layer system is configured to reduce the intensity of an external light beam reflected from the at least one reflective surface. In some embodiments, the anti-reflective multi-layer system is configured to reduce the intensity of a reflected light beam exiting the anti-reflective multi-layer system. In some embodiments, the intensity of the light beam (e.g., external light beam and/or reflected light beam) is reduced by, by about, by at least, or at least about, 10%, 20%, 30%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 80%, 90% or 99%, or any range of values therebetween.

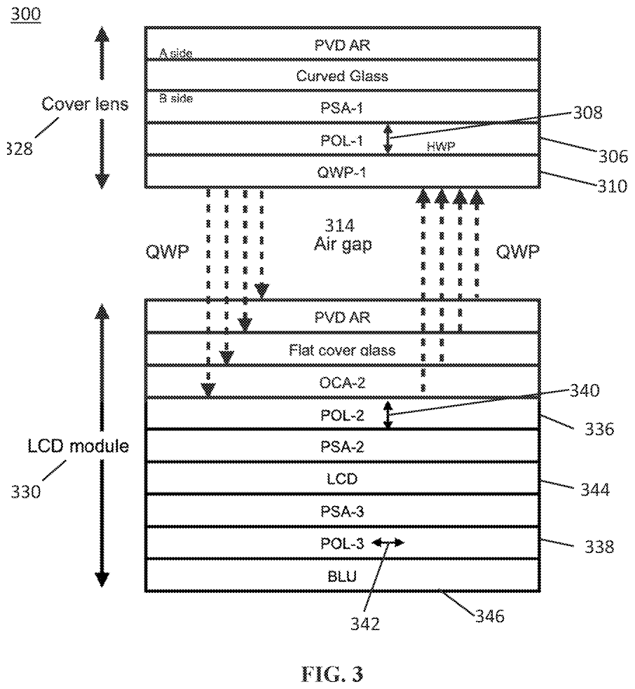

FIG. 3 is a cross-sectional schematic of an embodiment of a display system 300, and methods thereof. The display system 300 comprises a cover system 328 and a reflective system 330 (e.g., LCD module) separated by air gap 314. In certain embodiments, the cover system 328 comprises a first light-retardation layer 310 (“first quarter-wave plate”). In certain embodiments, the first light-retardation layer 310 converts linearly polarized light into circularly polarized light. In certain embodiments, a retardation value of the first light-retardation layer 310 is between about 100 nm to about 280 nm. In certain embodiments, the retardation value of the first light-retardation layer 310 is between about 100 nm to about 140 nm. In certain embodiments, a dispensation of the first light-retardation layer 310 is flat dispersion. In certain embodiments, the dispensation of the first light-retardation layer 310 is negative dispersion. In certain embodiments, the first light-retardation layer 310 comprises liquid crystal polymers. In certain embodiments, the first light-retardation layer 310 comprises a single layer. In certain embodiments, the first light-retardation layer 310 comprises multiple layers.

In certain embodiments, the cover system 328 comprises one or more polarization layers 306. In certain embodiments, the polarization layer 306 has the illustrated transmittance axis 308 (“first polarization filter”).

In certain embodiments, the reflective system 330 of the display system 300 comprises one or more polarization layers 336, 338. In certain embodiments, the polarization layers 336, 338 have the illustrated transmittance axes 340, 342 (“second and third polarization filter”), respectively. In certain embodiments, the second polarization layer 336 is disposed proximally or in front of an optical device 344 (e.g., LCD) and the third polarization layer 338 is disposed proximally or in front of an internal light source 346 (e.g., a back light). In certain embodiments, the transmittance axis 308 of the first polarization layer 306 is equal to the transmittance axis 340 of the second polarization layer 336.

In certain embodiments, light from an external light source passes through the first polarization layer 306, followed by passing through the first light-retardation layer 310, causing the light to become circular polarized. In certain embodiments, the circular polarized light reflects from one or more reflective surfaces of the reflective system 330 (e.g., liquid crystal display module).

For example, the circular polarized light reflects from one or more of anti-reflective top coating of the display device (PVD AR), interface between the PVD AR and cover glass, interface between the cover glass and optical adhesives (OCA-2), and interface between OCA-2 and the second polarization layer 336. After reflectance, circulation polarization reverses the circulation, as the transmittance axis 308 of the first polarization layer 306 is the same as the transmittance axis 340 of the second polarization layer 336 The reflected circular polarized light then passes through the first light-retardation layer 310, causing the light to become linearly polarized or half-wave plate (HWP) light, with a polarization axis perpendicular to that of the first polarization layer 306. Accordingly, the reflective light is blocked from the first polarization layer 306 due to different polarization axis.

In some embodiments, the anti-reflective multi-layer system and methods described herein relate to maintaining the intensity of an internal light beam. In some embodiments, the anti-reflective multi-layer system described herein is configured so that the intensity of an internal light beam is substantially similar after passing through the anti-reflective multi-layer system. Some embodiments of the present disclosure relate to methods of increasing transmitted light. In some embodiments, the anti-reflective multi-layer system further comprises a second light-retardation layer.

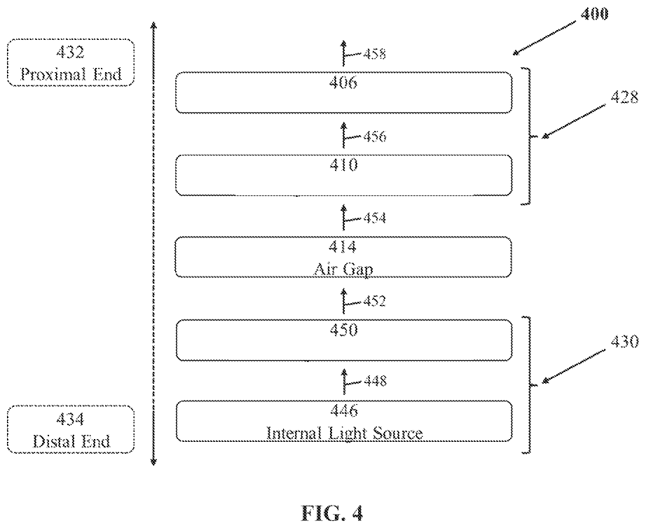

FIG. 4 is a schematic depiction of a cross-sectional view of an anti-reflective multi-layer system 400, and methods thereof. The anti-reflective multi-layer system 400 comprises a cover system 428; a reflective system 430; and an air gap 414. The cover system 428 is positioned at the proximal end 432 of the anti-reflective multi-layer system 400, the reflective system 430 is positioned at the distal end 434 of the anti-reflective multi-layer system 400, and the air gap 414 is disposed between the cover system 428 and the reflective system 430. The cover system 428 comprises a first polarization layer 406 and a first light-retardation layer 410. The first polarization layer 406 is positioned proximally to the first light-retardation layer 410. The reflective system 430 comprises at least one internal light source 446, and a second light-retardation layer 450. The second light-retardation layer 450 is positioned proximally to the internal light source 446. In some embodiments, the axis of the second light-retardation layer 450 and the axis of the first light-retardation layer 410 are crossed.

As depicted in FIG. 4, the internal light source 446 emits a light beam 448 into the anti-reflective multi-layer system 400. The light beam 448 passes through the second light-retardation layer 450, causing the light beam 448 to become a circular polarized light beam 452. The circular polarized light beam 452 passes through the air gap 414 and remains a circular polarized light beam 454. The circular polarized light beam 454 passes through the first light-retardation layer 410 to become a linear light beam 456, with a polarization axis parallel with that of the first polarization layer 406. Accordingly, the linear light beam 456 passes through the first polarization layer 406 to become an emitted light beam 458.

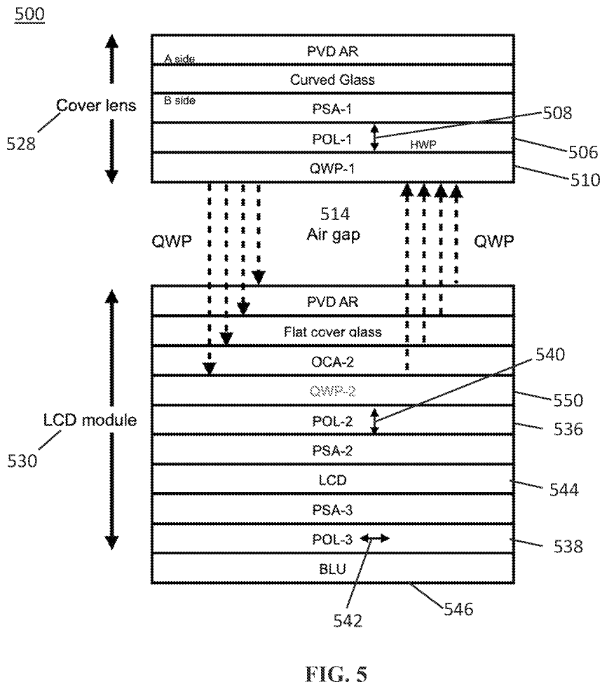

FIG. 5 is a cross-sectional schematic of an embodiment of a display system 500, and methods thereof. In some embodiments, the display system 500 is similar to the display system 300 of FIG. 3 except a reflective system 530 (e.g., LCD module) includes a second light-retardation layer 550. The display system 500 comprises a cover system 528 and the reflective system 530 separated by air gap 514. In certain embodiments, the second light-retardation layer 550 is disposed between the second polarization layer 536 of the reflective system 530 and the first polarization layer 508 of the cover system 528. The second polarization layer 536 has the illustrated transmittance axes 540, and the second polarization layer 536 is disposed proximally to an optical device 544 (e.g., LCD). Furthermore, the display system 500 comprises a third polarization layer 538 with the illustrated transmittance axes 542, and the third polarization layer 538 is disposed proximally an internal light source 546 (e.g., a back light). In some embodiments, an axis of the second light-retardation layer 550 and an axis of a first light-retardation layer 510 are crossed.

In certain embodiments, light from an internal light source passes through the second polarization layer 536 followed by passing through the second light-retardation layer 550, causing the internal light to become circular polarized. The polarization axis of the second light-retardation layer 550 is perpendicular to the first light-retardation layer 510. The circular polarized internal light then passes through the first light-retardation layer 510, becoming linear polarized. The polarization axis of the linear polarized internal light is parallel with the first polarization layer 506. As such, the linear polarized internal light passes through the first polarization layer 506, improving the brightness of the panel.

In some embodiments, the anti-reflective multi-layer system described herein is configured to maintain the intensity of an internal light beam. In some embodiments, the anti-reflective multi-layer system is configured to reduce the intensity of an internal light beam produced by the light generating layer and transmitted through the proximal end of the anti-reflective multi-layer system by, by about, by at most, or at most about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 40%, or 50%, or any range of values therebetween.

Other embodiments of the method described herein further comprise: circularly polarizing the light emitted by an internal light source, wherein the internal light passes through the second polarization filter and a second quarter-wave plate, generating a circular polarized internal light; and linearly polarizing the circular polarized internal light, wherein the circular polarized internal light passes through the first quarter-wave plate, generating a linear polarized internal light with a linear polarization which is parallel to the first polarization filter.

### Cover System

The anti-reflective multi-layer system comprises a cover system. In some embodiments, the cover system comprises a first polarization layer and a first light-retardation layer. In some embodiments, the first polarization layer positioned proximally to a first light-retardation layer. In some embodiments, the cover system further comprises a transparent layer. In further embodiments, the cover system further comprises an adhesive layer. In some embodiments, the adhesive layer is disposed between the transparent layer and the first polarization layer.

### First Polarization Layer

In some embodiments, the cover system comprises a first polarization layer. In some embodiments, the first polarization layer is positioned proximally to a first light-retardation layer. In some embodiments, the first polarization layer positioned adjacent to the first light-retardation layer. In some embodiments, the first polarization layer positioned between the transparent layer and the first light-retardation layer. In some embodiments, the first polarization layer positioned distally the transparent layer and adjacent to the first light-retardation layer.

### First Light-Retardation Layer

In some embodiments, the cover system comprises a first light-retardation layer. In some embodiments, the first light-retardation layer is positioned distally to a first polarization layer. In some embodiments, the first light-retardation layer is positioned adjacent to the first polarization layer.

In some embodiments, the first light-retardation layer has a retardation value of, of about, of at least, or at least about, 60 nm, 70 nm, 80 nm, 90 nm, 100 nm, 101 nm, 102 nm, 103 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 160 nm, 170 nm, 180 nm, 190 nm, or 200 nm, or any range of values therebetween. For example, in some embodiments, retardation value of the first light-retardation layer is or is about in any one of the following ranges: 80-160 nm, 90-150 nm, 100-140 nm, 110-130 nm, or 115-125 nm. In some embodiments, the first light-retardation layer comprises a quarter wave plate. In other embodiments, the first light-retardation layer is a quarter wave plate. In some embodiments, a dispensation of the first light-retardation layer is flat or negative. In some embodiments, a dispensation of the first light-retardation layer is flat. In some embodiments, a dispensation of the first light-retardation layer is negative. In some embodiments, the first light-retardation layer comprises a liquid crystal polymer layer.

### Transparent Layer

In some embodiments, the cover system further comprises a transparent layer. In some embodiments, the transparent layer is positioned proximally to the first polarization layer. In some embodiments, the transparent layer is positioned proximally to the first light-retardation layer. In some embodiments, the transparent layer is selected from the group consisting of a curved glass, a flat glass, a plastic film, and combinations thereof. In some embodiments, the transparent layer comprises a curved glass. In some embodiments, the transparent layer comprises a flat glass. In some embodiments, the transparent layer comprises a plastic film. In some embodiments, the first light-retardation layer is positioned distally to the transparent layer. In some embodiments, for example, the first light-retardation layer is positioned distally to the curved glass and distally to the first polarization layer.

In further embodiments, the transparent layer further comprises a coating layer selected from the group consisting of an anti-reflection coating, an anti-glare coating, a hard coating, a scratch-resistance coating, an impact-resistant coating, an abrasion-resistant coating, and combinations thereof. In some embodiments, the transparent layer comprises an anti-reflection coating. In some embodiments, the transparent layer comprises an anti-glare coating. In some embodiments, the transparent layer comprises a hard coating. In some embodiments, the transparent layer comprises a scratch-resistance coating. In some embodiments, the transparent layer comprises an impact-resistant coating. In some embodiments, the transparent layer comprises an abrasion-resistant coating.

### Reflective System

The anti-reflective multi-layer system comprises a reflective system. In some embodiments, the reflective system is positioned at a distal end of the anti-reflective multi-layer system. In some embodiments, the reflective system comprises at least one reflective surface. In some embodiments, the reflective system further comprises at least one of a second polarization layer, a second light-retardation layer, a light generating layer and a display system.

### Reflective Surface

The reflective system comprises at least one reflective surface. In some embodiments, the reflective system comprises 1, 2, 3, 4, 5, 6, 7, 8, 9, 10, 11, 12, 13, 15 or 20 reflective surfaces, or any range of values therebetween. In some embodiments, the reflective surface is positioned at a proximal end of the reflective system. In some embodiments, the reflective surface is positioned proximally to additional layers of the reflective system (e.g., a second polarization layer).

In some embodiments, the at least one reflective surface is a surface of a layer selected from the group consisting of an anti-reflection coating, an anti-glare coating, a hard coating, a scratch-resistance coating, an impact-resistant coating, an abrasion-resistant coating, a curved glass, a flat glass, a plastic film, an adhesive layer, a second polarization layer, and combinations thereof. In some embodiments, the at least one reflective surface is a surface of a layer selected from the group consisting of an anti-reflection coating, an anti-glare coating, a hard coating, a scratch-resistance coating, an impact-resistant coating, an abrasion-resistant coating, a curved glass, a flat glass, a plastic film, an adhesive layer, and combinations thereof.

### Second Polarization Layer

In some embodiments, the reflective system further comprises a second polarization layer. In some embodiments, the second polarization layer is positioned distally to the at least one reflective surface. In some embodiments, for example, the second polarization layer is positioned distally to the flat glass. In some embodiments, a transmittance axis of the first polarization layer is approximately equal to a transmittance axis of the second polarization layer.

In some embodiments, the reflective system comprises a plurality of polarization layers. In some embodiments, for example, the reflective system comprises a second polarization layer, a third polarization layer, and a fourth polarization layer. In some embodiments, the third polarization layer is positioned distally to the second polarization layer.

### Second Light-Retardation Layer

In some embodiments, the reflective system further comprises a second light-retardation layer. In some embodiments, the second light-retardation layer is positioned between the at least one reflective surface and the second polarization layer. In some embodiments, for example, the second light-retardation layer is positioned between the flat glass and the second polarization layer. In some embodiments, the second light-retardation layer is adjacent to the second polarization layer. In some embodiments, the second light-retardation layer is positioned between the at least one reflective surface and adjacent to the second polarization layer. In some embodiments, the second polarization layer is positioned distally to the second light-retardation layer. In some embodiments, the third polarization layer is positioned distally to the second light-retardation layer.

In some embodiments, the second light-retardation layer has a retardation value of, of about, of at least, or at least about, 60 nm, 70 nm, 80 nm, 90 nm, 100 nm, 101 nm, 102 nm, 103 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 160 nm, 170 nm, 180 nm, 190 nm, or 200 nm, or any range of values therebetween. For example, in some embodiments, retardation value of the second light-retardation layer is or is about in any one of the following ranges: 80-160 nm, 90-150 nm, 100-140 nm, 110-130 nm, or 115-125 nm.

In some embodiments, the second light-retardation layer comprises a quarter wave plate. In other embodiments, the second light-retardation layer is a quarter wave plate. In some embodiments, a dispensation of the second light-retardation layer is flat or negative. In some embodiments, a dispensation of the second light-retardation layer is flat. In some embodiments, a dispensation of the second light-retardation layer is negative. In some embodiments, the second light-retardation layer comprises a liquid crystal polymer layer.

### Light Generating Layer and Display System

In some embodiments, the reflective system further comprises a light generating layer. In some embodiments, the light generating layer is positioned distally to the second light-retardation layer. In some embodiments, the light generating layer is positioned distally to the second polarization layer. In some embodiments, the light generating layer is positioned distally to the third polarization layer. In some embodiments, the light generating layer is positioned adjacent to the second polarization layer. In some embodiments, the light generating layer is positioned adjacent to the third polarization layer.

In some embodiments, the reflective system further comprises a display system. In some embodiments, the display system comprises the light generating layer. In some embodiments, the display system is positioned distally to the at least one reflective surface. In some embodiments, the display system is positioned distally to the second polarization layer. In some embodiments, the third polarization layer is positioned distally to the display system. In some embodiments, the display system is positioned distally to the second light-retardation layer. In some embodiments, the display system is positioned between the second polarization layer and the third polarization layer. In some embodiments, the display system is positioned between the second light-retardation layer and the third polarization layer. In some embodiments, the display system is positioned between the at least one reflective surface and the third polarization layer. In some embodiments, for example, the display system is positioned between the flat glass and the third polarization layer.

In some embodiments, the display system is selected from the group consisting of a liquid-crystal display (LCD), an image display panel, a plasma display panel (PDP), a light emitting diode (LED), an organic light emitting diode (OLED), a cathode ray tube (CRT), a cold cathode fluorescent lamp (CCFL), an external electrode fluorescent lamp (EEFL), a backlight unit, a projector, and combinations thereof. In some embodiments, the display system comprises a liquid-crystal display (LCD). In some embodiments, the display system comprises an image display panel. In some embodiments, the display system comprises a plasma display panel (PDP). In some embodiments, the display system comprises a light emitting diode (LED). In some embodiments, the display system comprises an organic light emitting diode (OLED). In some embodiments, the display system comprises a cathode ray tube (CRT). In some embodiments, the display system comprises a cold cathode fluorescent lamp (CCFL). In some embodiments, the display system comprises an external electrode fluorescent lamp (EEFL). In some embodiments, the display system comprises a backlight unit. In some embodiments, the display system comprises a projector.

Some embodiments of the present disclosure relate to a vehicle comprising any one of the display systems disclosed herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed display system. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. An anti-reflective multi-layer system, comprising:
a cover system positioned at a proximal end of the anti-reflective multi-layer system, and comprising a first polarization layer positioned proximally to a first light-retardation layer;
a reflective system positioned at a distal end of the anti-reflective multi-layer system, and comprising at least one reflective surface; and
an air gap disposed between the cover system and the reflective system.

2. The anti-reflective multi-layer system of claim 1, wherein a retardation value of the first light-retardation layer is between about 100 nm to about 140 nm.

3. The anti-reflective multi-layer system of claim 1, wherein the first light-retardation layer comprises a quarter wave plate.

4. The anti-reflective multi-layer system of claim 1, wherein a dispensation of the first light-retardation layer is flat or negative.

5. The anti-reflective multi-layer system of claim 1, wherein the first light-retardation layer comprises a liquid crystal polymer layer.

6. The anti-reflective multi-layer system of claim 1, wherein the cover system further comprises a transparent layer.

7. The anti-reflective multi-layer system of claim 6, wherein the transparent layer is positioned proximally to the first polarization layer.

8. The anti-reflective multi-layer system of claim 6, wherein the transparent layer is selected from a group comprising a curved glass, a flat glass, a plastic film, and combinations thereof.

9. The anti-reflective multi-layer system of claim 6, wherein the transparent layer further comprises a coating layer selected from a group comprising an anti-reflection coating, an anti-glare coating, a hard coating, a scratch-resistance coating, an impact-resistant coating, an abrasion-resistant coating, and combinations thereof.

10. The anti-reflective multi-layer system of claim 6, wherein the cover system further comprises an adhesive layer disposed between the transparent layer and the first polarization layer.

11. The anti-reflective multi-layer system of claim 1, wherein the at least one reflective surface is a surface of a layer selected from a group comprising an anti-reflection coating, an anti-glare coating, a hard coating, a scratch-resistance coating, an impact-resistant coating, an abrasion-resistant coating, a curved glass, a flat glass, a plastic film, an adhesive layer, a second polarization layer, and combinations thereof.

12. The anti-reflective multi-layer system of claim 1, wherein the anti-reflective multi-layer system is configured to reduce an intensity of an external light beam reflected from the at least one reflective surface by at least about 50%.

13. The anti-reflective multi-layer system of claim 1, wherein the reflective system further comprises a second polarization layer positioned distally to the at least one reflective surface.

14. The anti-reflective multi-layer system of claim 13, wherein a transmittance axis of the first polarization layer is approximately equal to a transmittance axis of the second polarization layer.

15. The anti-reflective multi-layer system of claim 13, wherein the reflective system further comprises a second light-retardation layer positioned between the at least one reflective surface and the second polarization layer.

16. The anti-reflective multi-layer system of claim 13, wherein the reflective system further comprises a light generating layer positioned distally to the second polarization layer.

17. The anti-reflective multi-layer system of claim 16, wherein the anti-reflective multi-layer system is configured to reduce an intensity of an internal light beam produced by the light generating layer and transmitted through the proximal end of the anti-reflective multi-layer system by at most about 25%.

18. The anti-reflective multi-layer system of claim 1, wherein the reflective system further comprises a display system positioned distally to the at least one reflective surface.

19. The anti-reflective multi-layer system of claim 18, wherein the display system is selected from a group comprising a liquid-crystal display (LCD), an image display panel, a plasma display panel (PDP), a light emitting diode (LED), an organic light emitting diode (OLED), a cathode ray tube (CRT), a cold cathode fluorescent lamp (CCFL), an external electrode fluorescent lamp (EEFL), a backlight unit, a projector, and combinations thereof.

20. A vehicle comprising the display system of claim 18.

21. A method of reducing reflected light, comprising exposing the anti-reflective multi-layer system of claim 1 to an external light beam, wherein:
the external light beam passes through the cover system to form a circularly polarized beam;
the circularly polarized beam passes through the air gap and is reflected by the at least one reflective surface to form a reflected circularly polarized beam;
the reflected circularly polarized beam passes through the air gap and the cover system to form an exit beam; and
an intensity of the exit beam is less than an intensity of the external light beam.

22. A method of increasing transmitted light, comprising generating an internal light beam from the light generating layer of the anti-reflective multi-layer system of claim 16, wherein:
the internal light beam passes through the second polarization layer and a second light-retardation layer to form a circularly polarized beam;
the circularly polarized beam passes through the air gap and the cover system to form an emitted beam; and
an intensity of the emitted beam is at least about 75% of an intensity of the internal light beam.
